(19) United States
(12) Patent Application Publication
(10) Pub. No.: US 2004/0010622 A1
(43) Pub. Date: Jan. 15, 2004

(54) Method and system for buffering image updates in a remote application

(76) Inventors: Thomas G. O'Neill, Mountain View, CA (US); Jordan M. Slott, Sunnyville, CA (US)

Correspondence Address: WAGNER, MURABITO & HAO LLP, Third Floor, Two North Market Street, San Jose, CA, 95113, US

(21) Appl. No.: 10/323,959

(22) Filed: Dec. 17, 2002

Related U.S. Application Data
(63) Continuation-in-part of application No. 10/194,123, filed on Jul. 11, 2002.

(51) Int. Cl. G06F 15/16

(52) U.S. Cl. 709/247

(57) ABSTRACT

A method and system for buffering image updates for a remote application. An image update produced by a remote application is accessed for transmission from a host computer system to a display computer system. The image update is buffered to generate an image data set of the image update, wherein the image data set is configured for processing by an image compression routine. The buffering is performed by the host computer system. The image data set is processed using the image compression routine to produce a compressed image data set. The compressed image data set is subsequently transmitted to the display computer system via a network connection.

This application is a Continuation In Part of commonly assigned, copending U.S. application Ser. No. ______, TAGGING MULTICOLOR IMAGES FOR IMPROVED COMPRESSION, by Thomas G. O'Neill, et al.

### FIELD OF THE INVENTION

The field of the present invention pertains to the execution of software applications within a computer system environment. More particularly, the present invention relates to a method and system for streamlining graphical displays for remote applications in a computer system environment.

### BACKGROUND OF THE INVENTION

Computer systems are being used today to perform a wide variety of tasks. Many different areas of business, industry, government, education, entertainment, and most recently, the home, are tapping into the enormous and rapidly growing list of applications developed for today's increasingly powerful computer devices.

Software applications have also become a key technology for communicating ideas, data, and trends in most areas of commerce, science, and education. The operating system of a typical computer system comprises the primary means by which a user interacts with software applications installed on the computer. The typical operating systems are configured to interact with users through graphical user interfaces (GUIs) that support real time user interaction, two dimensional (2D) and three dimensional (3D) interactive images, visual representations of real-world system status, and the like.

The operating system and the associated services and capabilities provided there with is often referred to as an operating system environment. Included within the operating system environment is an array of software applications which provide different functions in accordance with the needs and requirements of the user and/or the intended purpose of the computer system. The software applications are often referred to as modules, extensions, or libraries, and function by extending the capability of the operating system environment.

The operating system is configured to facilitate the execution of software applications which provide services to the user. Usually, the software applications are installed locally on the same machine in which the operating system is installed. However, a trend has emerged wherein many applications provide their functionality remotely. Remote functionality typically refers to a software application which executes in whole, or in part, on a different computer system with respect to the user's computer system. Remote applications typically execute on an application server and provide their functionality across a network connection to a user's client machine. The user input and user output is accomplished through interaction with the user via, for example, graphical images, mouse clicks, keyboard entry, and the like, on the user's client machine. This requires a very close cooperation with the graphical images displayed on the client machine and the remote application executing on the server.

Within the field of remote computing applications, there are several different remote computing applications where screen information is entirely generated on one computer (e.g., the “host” computer or server) and transmitted for display on another computer (e.g., the “display” computer or client). The display computer can be a multipurpose computer, an X-terminal, a thin-client, or a Personal Digital Assistant (PDA). The latter three are limited-purpose computers, meaning they usually have no hard drive and some are designed only for the remote computing application. The host and display computers can communicate via any sort of network connection, including wireless.

One problem with prior art remote computing applications is the fact that the remote generation and transmission of application information across a network connection consumes a significant amount bandwidth. This is particularly true with respect to the graphics information of the remote application (images, etc.).

For example, for typical computing usage including web browsing, the host/display network bandwidth will in many cases be dominated by the transmission of images with a large number of colors. Examples of such images include digital photographic images of the natural world, whether taken with a digital camera or digitized from an analog camera print, computer-generated images of the natural world, or computer-generated images which include anti-aliased text or graphics. Thus, a need exists for reducing the network bandwidth used by remote computing applications.

One prior art solution for reducing the amount of network bandwidth consumed by a remote application involves the use of image compression-decompression routines (e.g., codecs). Some prior art remote display applications use RGB (red green blue) image codecs to compress such images for lower-bandwidth transmission. These codecs typically take advantage of spatial coherency in the image to achieve compression. This approach has a disadvantage in that the compression efficiency is reduced in cases where the complete multi-colored image is rendered as a contiguous sequence of smaller images instead of all at once. For example if the host computer is running an X-server, then the X-protocol limits the number of bytes that the client application can send to the server in a single protocol command. The limit can be as small as 16384 bytes, corresponding to only 4096 pixels. A more extreme example is a web browser application like Netscape, which enhances the user experience by rendering the available image information as it is down-loaded from the web. In this case the image can be rendered in chunks as small as a few pixels high, and a large image can take many rendering steps to complete. The smaller sub-images reduce the opportunity for the codec to exploit spatial coherency, and have reduced compression efficiency. This is especially pronounced when a block-based codec is used on a sub-image whose height is less than the block size: in this case the encoder must encode a region equal to the full height of the block, and the decoder discards the extra rows of pixel data.

Thus, in order to reduce the bandwidth used by remote computing applications, a need exists to efficiently compress many-colored images regardless of the number or size of rendering steps used to complete them.

### SUMMARY OF THE INVENTION

Embodiments of the present invention provide a method and system for buffering image updates for a remote display environment. The embodiments of the present invention function by reducing the network bandwidth consumed by a given remote display application, thereby resulting in shorter transmission times between the host and display computers, leading to a faster-updating remote display device. Embodiments of the present invention provide for a reduced bandwidth consumed, which leads to reduced load on the network, leading to improved network performance. Reduced bandwidth consumed also leads to the capability to use more such devices on a single network. Furthermore, embodiments of the present invention achieve the bandwidth reduction at the same time as a reduction in CPU utilization. CPU utilization is reduced on both host and display computers by reducing the total number of blocks that must be encoded and decoded.

In one embodiment, the present invention is implemented as a computer implemented method for buffering image updates for transmission from a remote application on a host computer system (e.g., server) to a display computer system (e.g., client). An image update produced by a remote application is accessed for transmission from a host computer system to a display computer system. The image update is buffered to generate an image data set of the image update, wherein the image data set is configured for processing by an image compression routine (e.g., image codec). The buffering is performed by the host computer system. The image data set is processed using the image codec to produce a compressed image data set (e.g., compressed image data). The compressed image data set is subsequently transmitted to the display computer system via a network connection.

In one embodiment, the image data set comprises a plurality of image blocks, wherein the dimensions of the blocks are configured for processing by the image codec.

In one embodiment, a symmetric (e.g., square) pixel grouping comprises each of the plurality of blocks. The number of pixels within the grouping is configured for processing by the image codec.

In one embodiment, the image codec is an RGB image codec configured for processing RGB image data. The host computer system can be configured to run an X-server application for processing the image update.

These and other advantages of the present invention will no doubt become evident to those of ordinary skill in the art after having read the following detailed description of the preferred embodiments which are illustrated in the various drawing Figures.

### BRIEF DESCRIPTION OF THE DRAWINGS

The present invention is illustrated by way of example and not by way of limitation, in the Figures of the accompanying drawings and in which like reference numerals refer to similar elements and in which:

FIG. 1 shows a generalized overview diagram of a system for buffering image updates for a remote application in accordance with one embodiment of the present invention.

FIG. 2 shows a diagram depicting the processing of the image update into a plurality of image blocks and the subsequent buffering and processing by the codec in accordance with one embodiment of the present invention.

FIG. 3 shows a diagram of a system wherein the host computer system is configured to run in an “X-server” application for processing the image update in accordance with one embodiment of the present invention.

FIG. 4 shows a flowchart of the steps of a process in accordance with one embodiment of the present invention.

FIG. 5 shows a more detailed diagram of an X-server based system in accordance with one embodiment of the present invention.

FIG. 6 shows a diagram of a queue entry array data structure in accordance with one embodiment of the present invention.

FIG. 7 shows a flowchart of the steps of a process that describes the handling of new boxes as they are added and removed from the RGB queue in accordance with one embodiment of the present invention.

FIG. 8 shows the general components of a computer system in accordance with one embodiment of the present invention.

FIGS. 9A-9B show flow diagrams illustrating a method for reducing the size of a graphics image in a computer system in accordance with one embodiment of the present invention.

FIG. 10 are flow diagram illustrating a method for compressing a rectangle in accordance with one embodiment of the present invention.

FIG. 11 is a flow diagram illustrating a method for reducing the size of a composite graphics image in a computer system in accordance with one embodiment of the present invention.

FIG. 12 is a flow diagram illustrating a method for reducing the size of a graphics image in a computer system in accordance with one embodiment of the present invention.

FIG. 13 is a block diagram illustrating an apparatus for reducing the size of a composite graphics image in a computer system in accordance with one embodiment of the present invention.

FIG. 14 is a block diagram illustrating an apparatus for reducing the size of a graphics image in a computer system in accordance with one embodiment of the present invention.

FIG. 15 is a block diagram illustrating an apparatus for reducing the size of a graphics image in a computer system in accordance with one embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Embodiments of the present invention provide a method and system for buffering image updates for a remote application. The embodiments of the present invention function by reducing the network bandwidth consumed by a given remote application, thereby resulting in shorter transmission times between the host and display computers, leading to a faster-updating display device. Embodiments of the present invention provide for a reduced bandwidth consumed, which leads to reduced load on the network, leading to improved network performance. Reduced bandwidth consumed also leads to the capability to use more such devices on a single network. Furthermore, embodiments of the present invention achieve the bandwidth reduction while simultaneously decreasing CPU utilization.

Notation and Nomenclature

Some portions of the detailed descriptions which follow are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

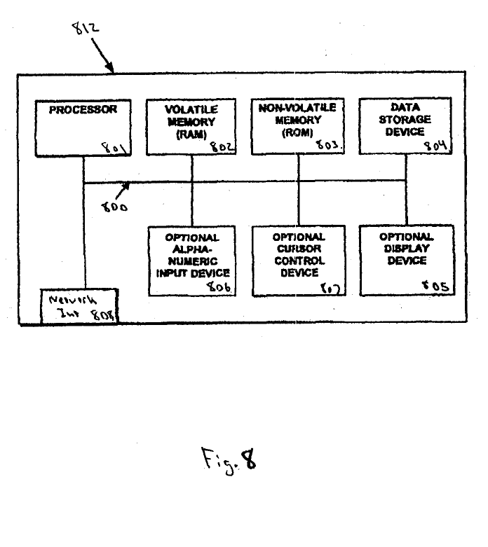

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “generating” or “accessing” or “communicating” or “executing” or “displaying” or the like, refer to the action and processes of a computer system (e.g., computer system 812 of FIG. 8), or similar electronic computing device, that manipulates and transforms data represented as physical (electronic) quantities within the computer system's registers and memories into other data similarly represented as physical quantities within the computer system memories or registers or other such information storage, transmission or display devices.

Method and System of the Invention

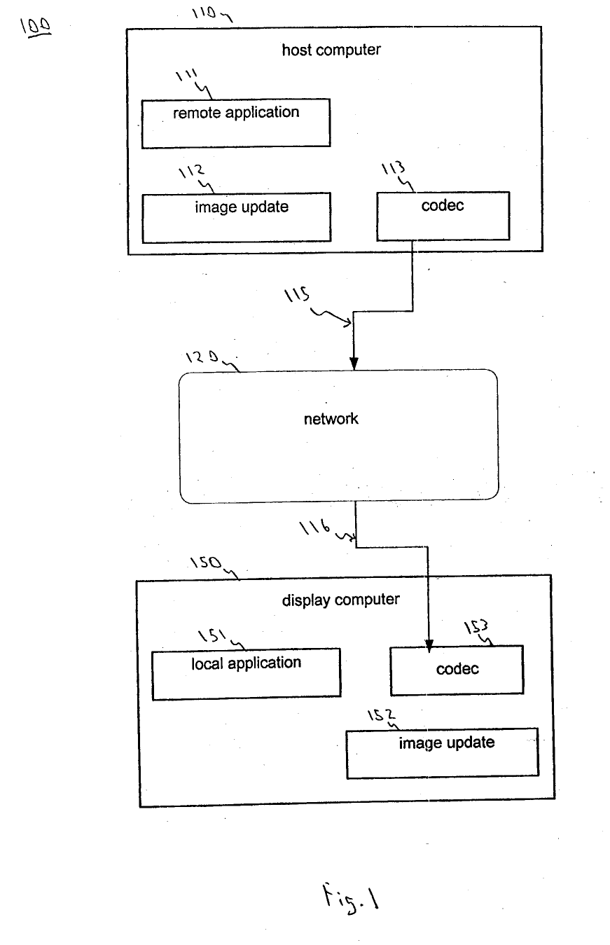

FIG. 1 shows a generalized overview diagram of a system 100 for buffering image updates for a remote application in accordance with one embodiment of the present invention. As depicted in FIG. 1, a host computer system 110 serves as a computer system platform for executing a remote application 111, image updates 112, and codec 113. The host computer system 110 is coupled to a display computer system 150 via the network connections 115-116 of a network 120. The display computer system 150 executes a local application 151, image updates 152, and codec 153.

In the system 100 embodiment, the present invention is implemented as a computer implemented method for buffering image updates, such as, image update 112, for transmission from the remote application 111 on the host computer system 110 (e.g., server) to the display computer system 150 (e.g., client). As shown in FIG. 1, the image update 112 is produced by a remote application, at times referred to as a client application. The image update 112 is accessed for transmission from the host computer system 110 to the network connected display (e.g., display) computer system 150.

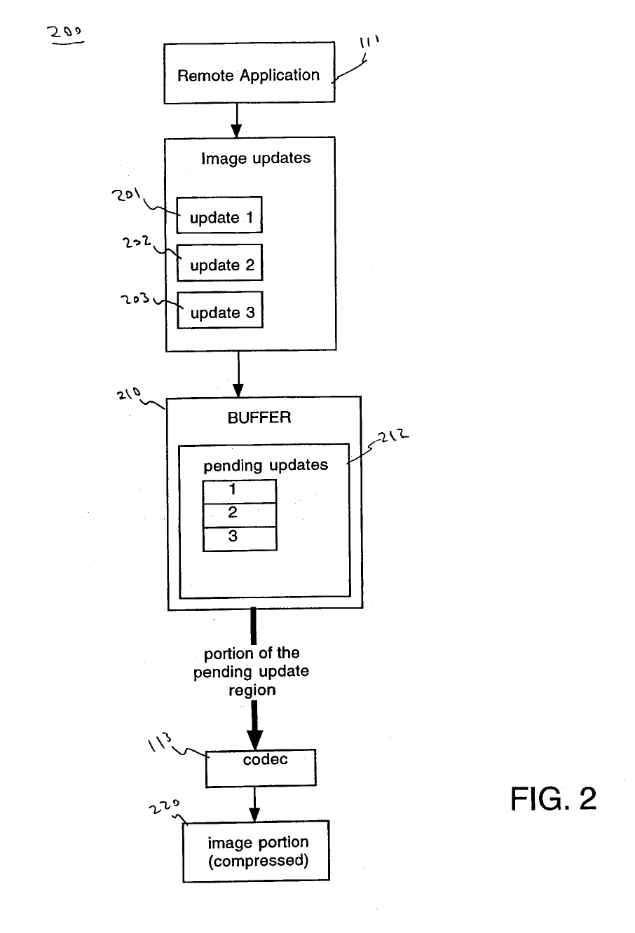

In order to reduce network bandwidth utilization, the image update 112 is buffered and processed by the codec 113 prior to transmission across the network 120. The compressed image data is then processed by the codec 153 upon reception by the display computer system 150. The compressed image data is decompressed into a corresponding image update 152 (which corresponds to the image update 112), which can be used by the local application 151 to update the display. The buffering and processing method is further described in FIG. 2 below. It should be noted that as used herein, the term “remote application” generally refers to an application primarily executing on the host computer system (e.g., server) and the term local application generally refers to an application primarily executing on the display computer system (e.g., client).

FIG. 2 shows a diagram depicting the buffering of image update regions to create a larger image update region, yielding improved compression. The image updates 201, 202, and 203 comprise sub-images of a larger image being rendered. It is important to note that these sub-images typically have differing sizes (e.g., number of rows). The update regions are accumulated into a single pending region 212 in buffer 210. Portions of this pending update region can be removed from the pending region periodically and compressed with the codec 113 to yield an update for the display computer. The portions should be chosen to yield good codec compression. Image codecs typically exploit spatial coherency to improve compression. Thus best compression results if the updates are accumulated until the entire image is deemed complete, so that only one portion is compressed and sent.

Nevertheless a large image can typically be compressed and sent in several portions, with little sacrifice in overall compression. This will result in a better user experience for cases where the last of its constituent sub-images arrives noticeably after the first sub-image. For example it can often take several seconds for Netscape to download and render a large RGB image.

The parameters with which the image data is buffered and the format in which the resulting buffered image data is provided to the codec is optimized to the specific characteristics of the particular codec. For example, block-based codecs (e.g., JPEG) are frequently used for compression of many-colored image data. Such codecs compress data in units of M×N pixel blocks, for some horizontal width M and vertical height N. If a block is partially full (e.g., at the right or bottom edge of an image), the full block must still be encoded and sent. The invention tremendously improves the efficiency of such codecs for cases where the sub-images (e.g., 201,202,203) are small compared to the codec block size. For example, when large JPEG images are loaded in Netscape they can be rendered in sub-images that are only a few (sometimes as few as one) lines high. Compression efficiency is improved by compressing and sending images in multiples of N pixels high, except when the bottom of the complete image is reached.

In the absence of the invention, the sub-image updates would be compressed immediately upon rendering and many of the encoded blocks would be only partially occupied by the sub-image. Much better results occur if the invention is used and the portion that is compressed and sent is chosen to consist of a plurality (e.g., a multiple of a full row) of image blocks. This ensures maximum occupancy of the blocks with image update data, greatly reducing the number of blocks encoded. This reduction in the number of encoded blocks results in a better overall compression for the image, and also reduces the amount of CPU cycles spent encoding (on the server) and decoding (on the client) the image update data.

For example, some codecs encode their data in units of 8 pixel by 8 pixel blocks. Thus, in the case where image information arrives as a stream of pixels, the image information will be accumulated until the requisite number of 8 by 8 pixel block rows can be defined. For example, if a single row of blocks is required, 8 rows of image information is accumulated.

As the update image 112 is incrementally generated by the remote application 111, the image data is buffered by the host computer system 110 using the buffer 210, wherein the buffer accumulates the image data until an update portion of the desired size and format is obtained. The portion is then transmitted to the codec 113.

In one embodiment, the transmission of the compressed image data (e.g., 220) to the display computer system 150 occurs asynchronously via the network connections 115-116 of the network 120. The transmission is asynchronous in that the transmission occurs some time after the image update 112 is drawn on the host computer, and that the time of transmission is chosen in order to optimize the compression and user experience. Asynchronous transmission allows different configurations of update regions to be transmitted. The sizes and formats of the update regions can be custom tailored to the characteristics of a particular codec (e.g., codec 113).

It should be noted that in one embodiment, the image codec 113 is an RGB image codec configured for processing RGB image data. As is well known, RGB image data comprises a widely used type of image data used for graphics and computer system applications. As used herein, an “RGB image” is defined as one that is rendered from a list of pixel values (as opposed, for example, to an image rendered from a specification of a geometric figure or text characters to draw). An “RGB image codec” is defined as a compression scheme that is intended for use on many-colored RGB images and uses the spatial coherency of the image to aid compression. Examples are lossless JPEG and lossy codecs based on the wavelet or DCT transforms.

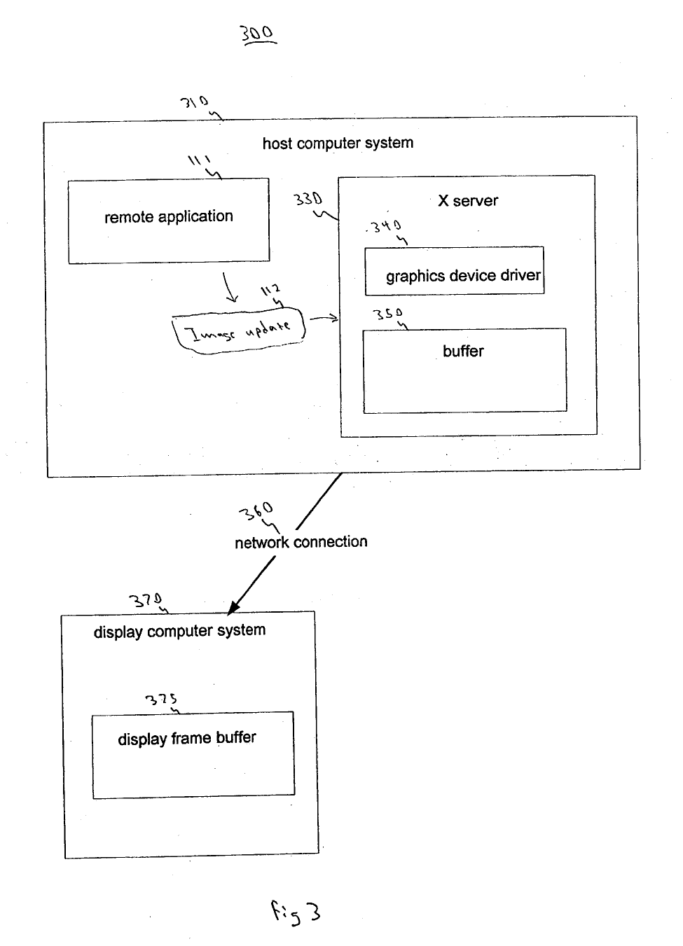

FIG. 3 shows a diagram of a system 300 wherein the host computer system 310 is configured to run an “X-server” application 330 for processing the image update in accordance with one embodiment of the present invention.

As shown in FIG. 3, the host computer system 310 of the system 300 embodiment can be configured to run the X-server application 330, which includes a graphics device driver 340 and a buffer 350, for processing the image update 112. As known by those skilled in the art, X-server comprises a graphics server program widely used on workstation and server platforms in computer system networks. Additionally, X-server applications can be obtained for a variety of different platforms, such as, for example, Windows platforms, Macintosh platforms, and the like. In an X-server environment, the X-server application 330 functions as the “graphics layer” for the applications executing on the host computer system 310. Generally, applications wishing to display graphics information (e.g., remote application 111) execute calls to the X-server application 330, which then performs the graphics processing required to implement the images.

Referring still to FIG. 3, the X-server application 330 includes a graphics device driver 340 which processes graphics information into a buffer 350. The buffer 350 is used to accumulate the graphics information from the image updates into the required image block format in accordance with the present invention. Once the image block format is obtained, system 300 functions in the manner described above in the discussion of FIG. 2. The compressed image blocks are subsequently received by the display computer system 370 and rendered into the display frame buffer 375 for display to the user.

Thus, embodiments of the present invention can be used by any remote display application where the host computer uses an RGB image codec to compress RGB images for transmission to the display computer. As used herein, an “RGB image” is defined as one that is rendered from a list of pixel values (as opposed, for example, to an image rendered from a specification of a geometric figure or text characters to draw). In an X-server (e.g., X-server application 330), such images are typically created using the “XPutImage” command.

Embodiments of the present invention are useful in cases where single RGB images are rendered in multiple steps (sub-images). In these cases, the RGB image updates are buffered (or queued) and sent asynchronously to the client according to a schedule determined by heuristics evaluated on the host computer. This improves the compression efficiency of the RGB codec by increasing the size of the image rectangle where the coherency is exploited.

Referring still to FIG. 3, the X-server application 330 allows the remote application 111 to draw to either off-screen pixel maps or to windows (which can appear on-screen), collectively referred to as “drawables.” In one embodiment, an RGB image can be created in a drawable either 1) directly via the XPutImage command or 2) indirectly by using “XCopyArea” to copy to the drawable a portion of a pixel map that itself contains an RGB image. RGB images are made visible when the destination drawable of an XPutImage or XCopyArea is a realized (on-screen) window.

The source pixel map in an XCopyArea command may be a composite image with both RGB and non-RGB regions. Any one of several techniques can be used to identify the location of the RGB regions. One such method for identifying the RGB region in a pixel map is described in commonly assigned U.S. patent application “TAGGING MULTICOLOR IMAGES FOR IMPROVED COMPRESSION” by Thomas G. O'Neill and Jordan Slott, filed on Jul. 17, 2002, which is incorporated herein in its entirety. An alternative method would rely on after-the-fact pixel inspection to identify many-colored regions.

In the present embodiment, there are at least two main ways to buffer RGB image updates using the buffer 350. In one method the system designer insists on maintaining continuous agreement between the host and display computers on the state of the screen image. In this method, the commands for rendering the sub-images are not performed immediately, but are instead buffered using the buffer 350. When the image is complete, a single rendering command is performed to render the entire image at once and an update is sent to the display computer. The other method is to not interfere with the rendering of the images on the host computer 310, but to delay sending RGB image updates to the display computer 370.

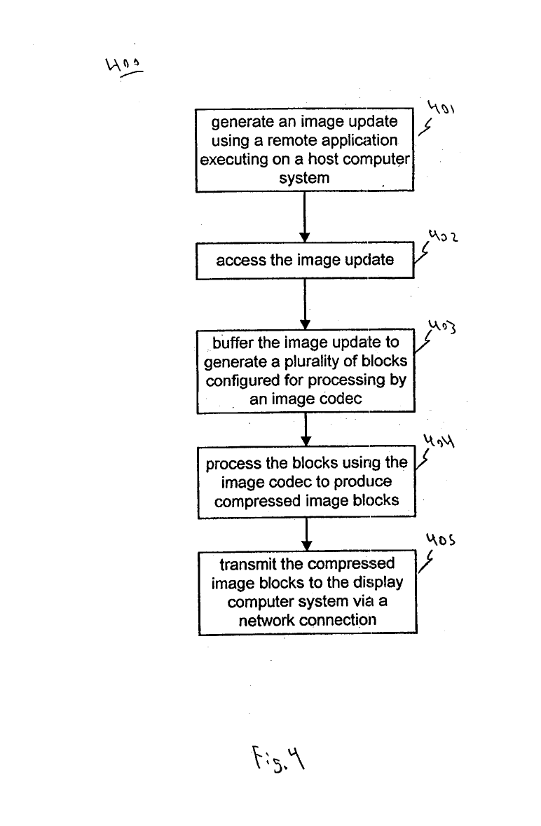

Referring now to FIG. 4, a flowchart of the steps of a process 400 in accordance with one embodiment of the present invention is shown. As depicted in FIG. 4, process 400 shows the steps involved in buffering image updates for a remote application in accordance with one embodiment of the present invention.

Process 400 begins in step 401, where a new image (e.g., image update 112) is generated using a remote application (e.g., remote application 111) executing on a host computer system (e.g., the host computer system 110). In step 402, the image update is accessed. In step 403, the image update is buffered using a buffer (e.g., buffer 210) in order to generate a plurality of blocks configured for processing by an image codec (e.g., image codec 113). As described above, the configuration of the blocks is such that efficient computation and processing is facilitated in the image codec 113. In step 404, the blocks are processed using the image codec to produce compressed image blocks. Subsequently, in step 405, the compressed image blocks are transmitted to the display computer system (e.g., display computer system 150) via the network connection.

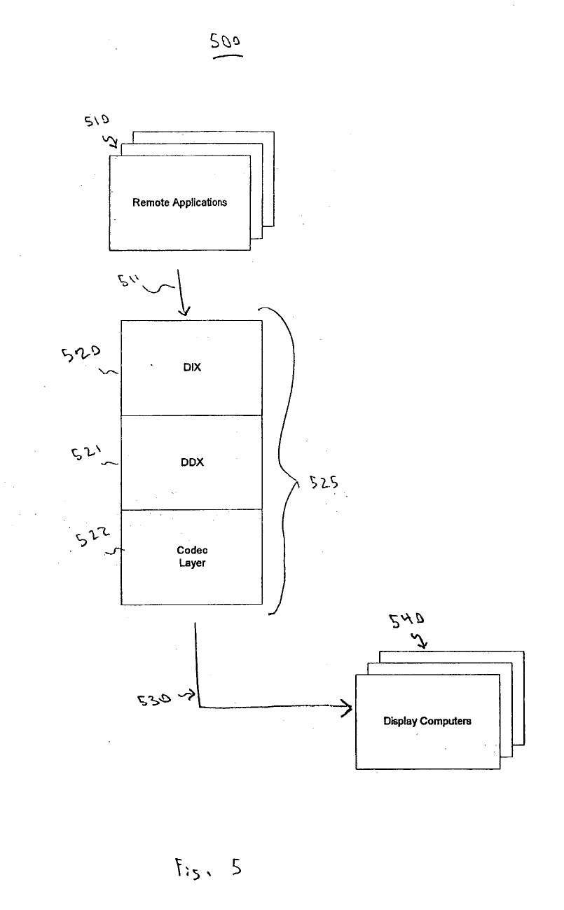

Referring to FIG. 5, a more detailed diagram of an X-server based system 500 in accordance with one embodiment of the present invention is shown. System 500 shows additional details of the components of an X-server based system as it executes an image update buffering process in accordance with one embodiment of the present invention.

As depicted in FIG. 5, system 500 includes the remote applications 510 (e.g., client applications, and the like) communicating via an X Windows Protocol. As described above, the remote applications 510 generate image updates. The host computer utilizes a device independent layer (DIX) 520 to act as a controlling layer, which handles initialization procedures and all device-independent handling of requests and events. A device dependent layer (DDX) 521 then is used to handle device dependent functionality. A codec layer 522 then performs the image buffering, compression, etc. The codec layer 520 then transmits the compressed image information to the display computers 540 using a protocol communication 530.

As described above, the X-server 525 (e.g., components 520-522) allows the remote applications 510 to draw to either off-screen pixel maps or to windows (which can appear on-screen), collectively referred to as “drawables.” In the system 500 embodiment, an RGB image can be created in a drawable directly via the XPutImage command, or indirectly by using an XCopyArea command to copy to the drawable a portion of a pixel map that itself contains an RGB image.

In the system 500 embodiment, there are two main ways to buffer RGB image updates. In one method the system designer insists on maintaining continuous agreement between the host and display computers on the state of the screen. In this method, the commands for rendering the sub-images are not performed immediately, but are instead buffered. When the image is complete, a single rendering command is performed to render the entire image at once and an update is sent to the display computer. This is relatively simple for XCopyArea since the X-server 525 maintains the state of the full source pixel map. For example, in a case where images are incrementally rendered (e.g., as in Netscape Web browsers), the sub-images are drawn on a pixel map with XPutImage and then copied to a realized window with XCopyArea. The XPutImages occur to different portions of the pixel map such that after the final sub-image is rendered, the pixel map contains the full image. Thus a single XCopyArea of this pixel map is equivalent to the series of XCopyArea commands that, for example, a Netscape Web browser requests.

It should be noted that buffering XPutImage commands may be more difficult to implement due to the fact that the X-server 525 does not have continuous access to the source pixel map during the buffering period. Thus the X-server 525 would have to maintain its own copies of the source pixel maps for the pending XPutImage command. It may be preferable for system designers practicing this method to buffer only XCopyArea commands, which in any case show the largest gains from buffering.

In another method, the rendering of the images on the host computer is not interfered with, but is delayed with respect to sending RGB image updates to the display computers 540. In the system 500 embodiment, this method can be used with equal ease for both XCopyArea and XPutImage, since the buffered RGB images are stored without modification on the host's screen pixel map. This method, wherein the sending RGB image updates is delayed with respect to the rendering of the images on the host computer, is described in greater detail below.

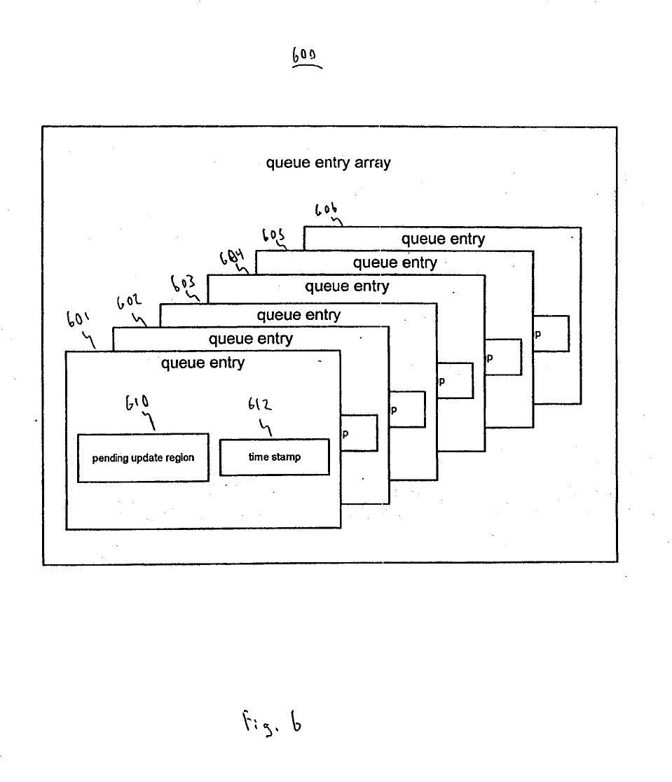

FIG. 6 shows a diagram of a queue entry array 600 in accordance with one embodiment of the present invention. In one embodiment the host computer maintains the list of buffered RGB updates as a (fixed- or adjustable-length) array of structures called queue entries (e.g., queue entries 601-606 shown in FIG. 6). Each queue entry represents a single RGB image where some portion of the image has been rendered on the host computer without informing the display computer of the update.

The first member of the queue entry data structure is called the “pending update region,” (e.g., pending update region 610). It represents the portion of the image that has been rendered on the host computer but has not been compressed and sent to the display computer. In one embodiment, the pending region 610 is a pointer to an X region structure, describing the pending region in screen coordinates. This allows direct manipulation of the pending region with the X-server's region routines. The actual image data is stored in the host computer's software frame buffer and therefore does not need to be stored in the queue entry data structure.

With respect to X region structures and routines, a region resource may be used to describe an arbitrarily shaped piece of real estate in XY pixel space. For example, a region resource can be used to describe an arbitrary collection of pixels by characterizing their XY positions. In X, the positions are characterized by an array of rectangles for which every pixel is in the region. This representation is efficient for regularly-shaped regions, which occur frequently in X, but inefficient for regions with a lot of isolated pixels, which occur much less frequently in X. The rectangle representation is also very convenient for remote display applications such as Sun Ray™, where each protocol command specifies the screen update for a single screen rectangle.

X also provides a series of routines for performing set operations (union, subtraction, intersection, etc.) on the region resources, which are very convenient in the practice of the invention. The region resources and routines were originally developed to assist with the computation of clipping and drawn-to regions. The composite clip list for a drawable (window or pixmap) represents the region that can currently be drawn to. It includes the effects of clipping requested by the client application (the client clip list) and, if the drawable is a window, by other windows that are on top of the window in question. The drawn-to region for a particular DDX command is found by intersecting the composite clip list with the region that the command would render in the absence of clipping. It is this region to which the command actually renders.

The second member of the queue entry data structure is a time stamp 612. The time stamp 612 is the latest time at which a sub-image was added to the entry 601's pending region. The time stamp 612 is used to ensure that the update for the image is sent to the display computer within a reasonable period of time. If the delay since the time stamp 612 exceeds a time threshold “dtime_flush” (e.g. 0.4 seconds), the image is assumed to be complete and the entire pending region is compressed and sent to the display computer. In most cases, flushes will result in a row of codec blocks that are only partially occupied with the RGB image. Because of this the system designer should choose a time dtime_flush that is longer than the typical time between the rendering of sub-images and short enough that the delay in completing the image is not annoying to the user. Following a flush, the queue entry 601 can be deleted. In this case the array of queue entries 600 can be compacted to remove the empty entry.

In one embodiment flushing is triggered by expiration of a timer set with the TimerSet( ) function in “WaitFor.c.” When there is an update to the RGB queue (e.g. adding to an entry's pending region, or flushing an entry), the timer can be set for the flush time of the longest-pending entry.

It should be noted that the update for a buffered RGB region should be sent before the queued image is overwritten. For example this is necessary for proper display of animations. Thus before any wide-area rendering command like XPolyFillRect, XPutImage, and XCopyArea is executed, it may be preferable to flush any RGB entries that are about to be overwritten. In a typical implementation, if any rectangle in the region about to be rendered overlaps an existing pending region, the entire RGB queue is flushed. In most cases, the penalty for occasional premature flushes in unaffected RGB queue entries is small enough that a more sophisticated implementation is unnecessary. Alternatively, an implementation can be configured where the flushing is restricted only to entries for the window being written to.

The process in which RGB sub-images get added to the RGB queue is now described. In the present embodiment, the queuing software is configured to assume that a large image is rendered as a sequence of equal-width sub-images, starting at the top of the image and descending to the bottom. For example, in one embodiment, for each XCopyArea or XPutImage command, the host computer computes the region of the screen in which new RGB sub-images are created. For XPutImage the RGB sub-image region is given as the intersection of the composite clip list with the destination rectangle. For XCopyArea the region is the intersection of the composite clip list, the destination rectangle, and the RGB region of the source pixel map (translated to the destination coordinates). Because the composite clip list or the source RGB region (for XCopyArea) can be non-rectangular, the sub-image region may require more than one rectangle to describe.

RGB image codecs typically compress, and remote display protocols typically send, one rectangular region at a time. Thus in one embodiment the pending region of a single RGB entry always consists of exactly one rectangle (“box”). Individual boxes comprising the new sub-image(s) are considered by the queuing routine “queuergbbox” one at a time. The host computer then checks to see if the top of the new box is contiguous with the bottom of the pending rectangle for an existing RGB entry. If so then two cases occur: 1) if the new box has the same starting and ending x-coordinates as the pending rectangle, it is said to “extend” the RGB entry; 2) otherwise the existing RGB entry is flushed. It is flushed because the pending rectangle and the new box must in any case be compressed and sent separately, so there is no reason to delay further the display of the pending rectangle. The flushing also prevents potential complications from cases where a wide new box extends more than one RGB entry, and therefore connects two previously disconnected images.

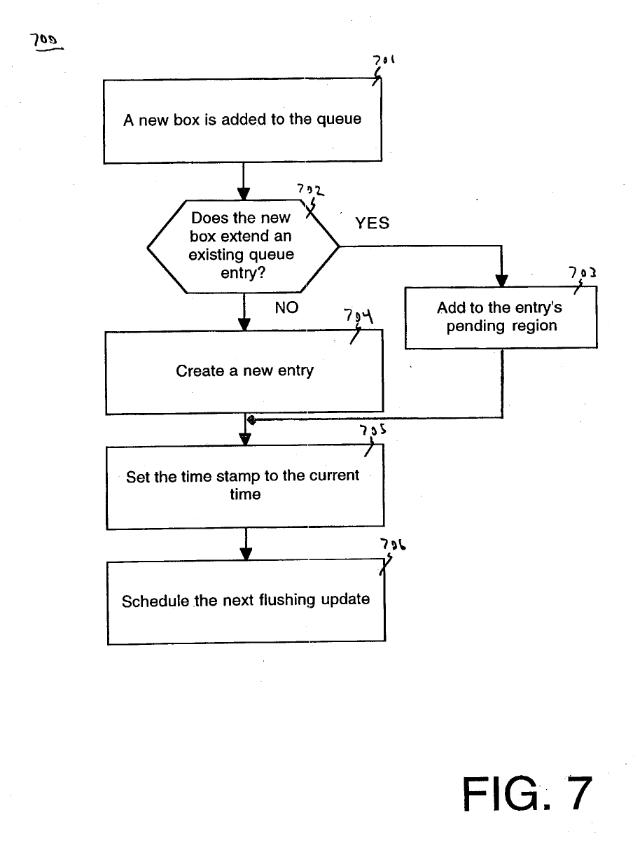

Referring now to FIG. 7, a flowchart of the steps of a process 700 is shown that describes one exemplary method for the handling of new boxes as they are added and removed from the RGB queue. The following discussions proceed with reference to process 700.

The process 700 embodiment begins with the arrival of a new box being added to the RGB queue. As shown by step 702, the new box is checked to determine whether it extends an existing queue entry. In step 703, if the new box extends the existing queue entry, it is added to the entry's pending region, and process 700 proceeds to step 705. Otherwise, process 700 proceeds to step 704, where a new queue entry is created. In step 705, the time stamp is set to the current time and the pending region for the new entry is set to consist of the new box. In step 706, queuergbbox calls TimerSet( ) to schedule the next flushing update, in the manner described above.

It should be noted that depending upon the particular implementation, additional precautions may be necessary to ensure proper functioning of the RGB queuing. For example, many DDX screen routines could potentially influence the validity of one or more RGB entries. For example DestroyWindow and UnrealizeWindow calls signal that any partially-queued RGB images in the window are about to be removed or become invisible. ChangeWindowAttributes (e.g. on window resizing or a change in its front-to-back ordering), ClearToBackground, and PaintWindowBackground signal that such images might become invisible or be overwritten. CreateWindow, MoveWindow, PositionWindow, and RealizeWindow calls signal that the affected window may obscure any partially-queued RGB images in other windows. MoveWindow and PositionWindow also indicate that pending images may be moved to a new location.

In the present embodiment, all pending RGB queue entries 601-606 are flushed whenever one of the above routines is called. Generally, the penalty for occasional premature flushes in unaffected RGB queue entries is small enough that a more sophisticated implementation is unnecessary. It should be noted that there may be some redundancy in the list of routines (e.g. some of these routines are probably only called by others).

It should be noted that depending upon the particular requirements of a user, several further complications may be considered by the system designer. For example it can often take several seconds for Netscape to download all of the RGB images in a page. In the embodiments discussed in conjunction with FIGS. 6 and 7, the user would see no image display progress until the images were complete and the flushing updates occurred. A better user experience occurs if “draining updates” are also implemented, which provide earlier display of partial images with negligible incremental bandwidth penalty. In a draining update, a portion of the pending region is compressed and sent, and the size of the pending region is thus reduced. A draining update is applied when an entry does not qualify for a flushing update but has a pending region consisting of more than “npix_drain” (e.g. 1000) pixels. The threshold npix_drain ensures that the size of the compressed data is large compared to any protocol command overhead associated with sending the update. The number of rows in the draining update can be obtained, for example, by rounding down the number of pending rows to the nearest integer multiple of the block size.

In one embodiment, the system designer may wish to provide a time-out as an additional trigger of a draining update, to ensure timely arrival of partial image updates. In this case the meaning of the time stamp should be changed to be the time of the entry's latest draining update or, if no draining has occurred, the time at which the entry was created. Thus a draining update is also triggered if the delay since the time stamp exceeds a threshold value dtime_drain (e.g. 0.25 seconds) and the number of rows in the pending region equals or exceeds the codec block dimension. Note that the advantages of queuing will be lessened if too short a value of dtime_drain is chosen. The new definition of the time stamp does not negatively affect the flushing time-outs.

For the best user experience, draining updates should preferably be attempted frequently, so the TimerSet( ) guidelines described above are not appropriate. The simplest implementation of draining is to always set the TimerSet( ) expiration time a fixed time dtime_min (e.g. 0.05 seconds) in the future whenever there is a change in the RGB queue and the queue is not empty. When the timer expires, entries are tested to see if they are ready for flushing or draining updates. The test is fast, so there is little penalty for choosing a small value of dtime_min.

For block-based codecs, draining updates should always remove an integral number of codec block rows. If the draining update empties the pending region, the entry is deleted.

It should be noted that the system designer may also wish to take advantage of cases where there is an independent indication that the RGB image is complete, such as when the RGB image extends to or beyond the bottom of the visible portion of the destination window. In these cases the affected RGB entry can be flushed immediately after the new box is added to the pending region of an existing or new RGB entry. This minimizes the delay before the RGB update occurs.

It should also be noted that although a system designer may be tempted to flush some or all of the RGB queue entries when non-RGB output occurs, such a solution is not preferred. For example, such a solution does not guarantee that the RGB images are complete. For example Netscape typically updates the progress bar and text at the bottom of the browser window several times while the images in a page load. Even if a more sophisticated implementation were attempted (e.g. only flushing the RGB entries for the window where the non-RGB output occurs), one would still have to implement draining and flushing updates: there is no guarantee that the RGB output would be followed by timely non-RGB output.

Computer System Platform

With reference now to FIG. 8, a computer system 812 in accordance with one embodiment of the present invention is shown. Computer system 812 shows the components of a computer system in accordance with one embodiment of the present invention that provides the execution platform for implementing certain software-based functionality of the present invention. As described above, certain processes and steps of the present invention are realized, in one embodiment, as a series of instructions (e.g., software program) that reside within computer readable memory units of a computer system (e.g., system 812) and are executed by the processor(s) of system 812. When executed, the instructions cause the computer system 812 to implement the functionality of the present invention as described above.

In general, computer system 812 comprises an address/data bus 800 for communicating information, one or more central processors 801 coupled with the bus 800 for processing information and instructions, a computer readable volatile memory unit 802 (e.g., random access memory, static RAM, dynamic, RAM, etc.) coupled with the bus 800 for storing information and instructions for the central processor(s) 801, a computer readable non-volatile memory unit 803 (e.g., read only memory, programmable ROM, flash memory, EPROM, EEPROM, etc.) coupled with the bus 800 for storing static information and instructions for the processor(s) 801. System 812 also includes a mass storage computer readable data storage device 804 such as a magnetic or optical disk and disk drive coupled with the bus 800 for storing information and instructions. Optionally, system 812 can include a display device 805 coupled to the bus 800 for displaying information to the computer user, an alphanumeric input device 806 including alphanumeric and function keys coupled to the bus 800 for communicating information and command selections to the central processor(s) 801, a cursor control device 807 coupled to the bus for communicating user input information and command selections to the central processor(s) 801, and a network interface device 808 coupled to the bus 800 for communicating with other computer systems on a coupled network.

Thus, embodiments of the present invention provide a method and system for buffering image updates for a remote application. The embodiments of the present invention function by reducing the network bandwidth consumed by a given remote application, thereby resulting in shorter transmission times between the host and display computers, leading to a faster-updating display device. Embodiments of the present invention provide for a reduced bandwidth consumed, which leads to reduced load on the network, leading to improved network performance. Reduced bandwidth consumed also leads to the capability to use more such devices on a single network. Furthermore, embodiments of the present invention achieve the bandwidth reduction while at the same time lowering CPU utilization.

Tagging of Multicolor Images for Improved Compresssion

Embodiments of the present invention wherein tagging of multicolor images is implemented to improve compression are now described.

Tagging embodiments of the present invention implement the storing of not only image content but information regarding what commands were used to create the image allows for well-informed decision making. The drawing commands are recorded and may be stored in a data structure. This data structure may then be accessed at the time of compression, and the selection of which compression techique to use may be based on the drawing commands. Thus, certain codecs may be applied to certain portions of the image, resulting in a more efficiently compressed image. Pixmaps are data structures holding pixel values corresponding to an image in memory. The data structure utilized here may be a separate RGB pixmap region associated with a pixmap holding image data. This permits the well-informed decision making to be accomplished even when pixmaps are copied to realized (on-screen) windows or other pixmaps.

The tagging embodiments of the present invention provides a mechanism to identify images with many colors for special treatment. As will be seen in the descriptions below, this results in the ability to dramatically reduce network bandwidth while still maintaining image quality.

Embodiments of the present invention enable well-informed decision making when pixmaps are copied to realized windows. In one embodiment, this is accomplished by maintaining and using information about how the pixmap image was created to achieve better decision making about how best to compress the image data. Additionally, it should be pointed out that for purposes of this application, the term pixmap should be construed to cover traditional pixmaps as well as any other type of image staging area that isn't part of the final image being created. In fact, the invention may be used any time it is useful to compress a set of image data that has been created with a sequence of drawing commands, and information is available about what commands were used for different portions of the image.

One example use for the present invention would be to improve compression of images created in pixel-based (as opposed to vector-based) drawing programs. Here, one might keep track of the drawing commands (circle, filled circle, square, image importation, etc.) used to draw the different portion of the image and use that information to influence compression decisions when saving the results to a file.

The embodiments disclosed below are described in the context of a modification of traditional X Windows technology for use with remote computing applications. However, one of ordinary skill in the art will recoginize that other embodiments are possible and the present invention should not be limited to X Windows, SunRay™, or remote computing technology.

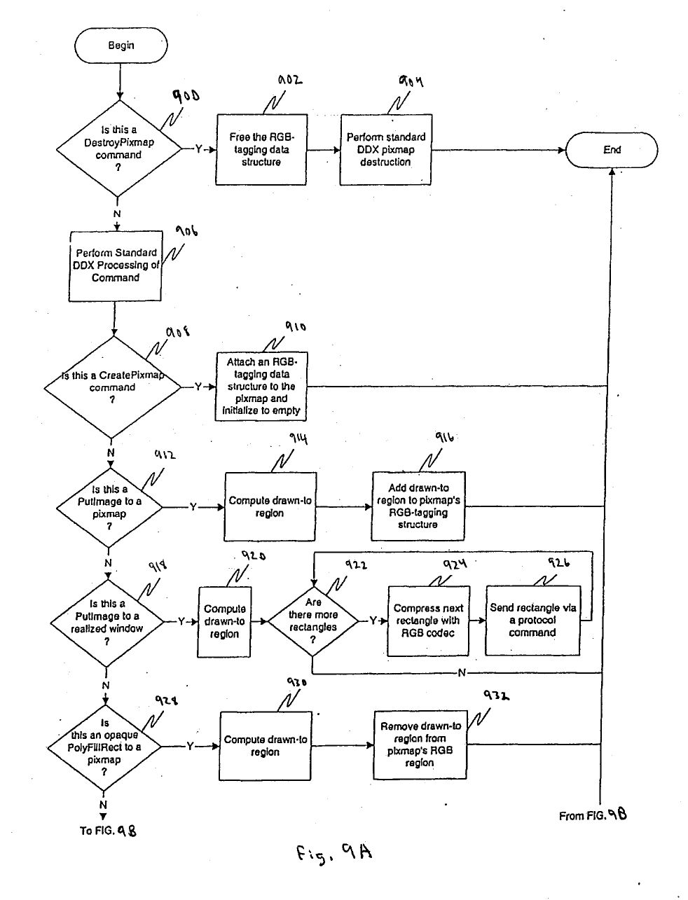

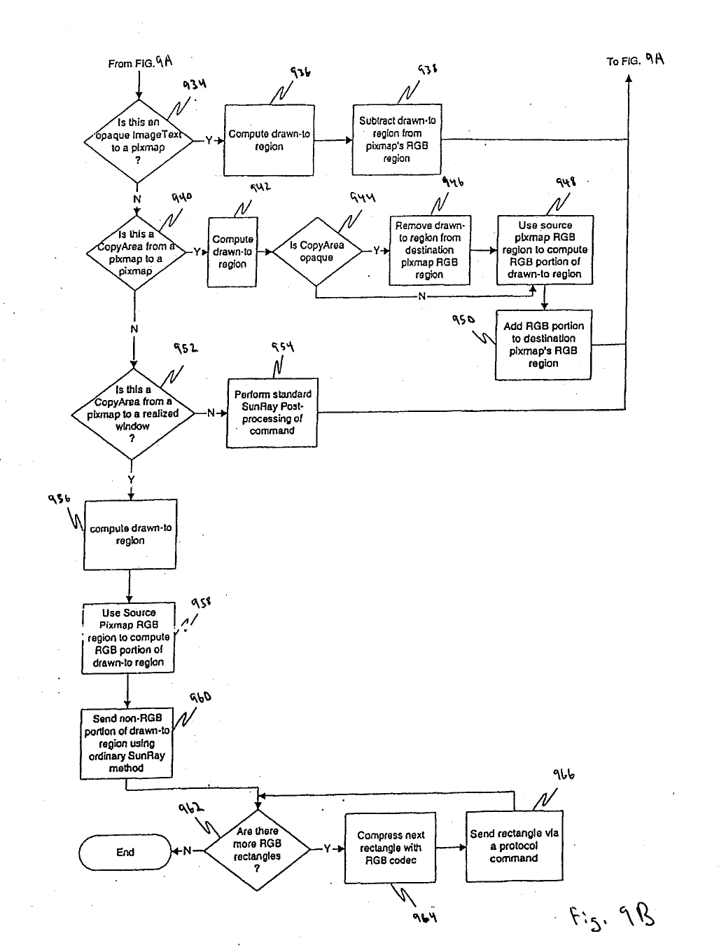

FIGS. 9A-9B are flow diagrams illustrating a method for reducing the size of a graphics image in a computer system in accordance with a specific embodiment of the present invention. These figures show the processing of a single DDX command in accordance with a specific embodiment of the present invention. These figures refer specifically to an embodiment where the SunRay™ server software is modified to practice the invention. One of ordinary skill in the art will recognize that this method may be modified for use with other remote display applications. In this embodiment, several DDX commands may require special handling. These include CreatePixmap, DestroyPixmap, PutImage, PolyFillRect, ImageText, and CopyArea. Referring first to FIG. 9A, at 900, it is determined if the command is a DestroyPixmap command. It should be noted that one of ordinary skill in the art will recognize that a destroy pixmap command, any command utilized to destroy or remove a pixmap or pixmap-like structure, could be substituted for DestroyPixmap. If it is a DestroyPixmap command, then at 902, the RGB-tagging data structure may be freed and at 904 the standard DDX pixmap destruction may be performed. If it is not a DestroyPixmap command, then at 906 the standard DDX routine for the command is called.

At 908 it is determined if the command is a CreatePixmap command. It should be noted that one of ordinary skill in the art will recognize that a create pixmap command, any command utilized to create a pixmap or pixmap-like structure, could be substituted for CreatePixmap. If the command is a CreatePixmap command, then at 910, an RGB tagging data structure is attached to the pixmap and the RGB region is initialized to empty.

At 912, it is determined if the command is a PutImage to a pixmap. It should be noted that one of ordinary skill in the art will recognize that a put image command, any command utilized to create an RGB image, may be substituted for PutImage. If so, then at 914 the drawn-to region is computed. Then at 916, the drawn-to region is added to the pixmap's RGB region and processing is complete. If the command is not a PutImage to a pixmap, then at 918 it is determined if the command is a PutImage to a realized window. If so, then at 920 the drawn-to region is computed. Then, at 922 it is determined if there are any more rectangles in the drawn-to region. If so, the process moves to 924. Thus, for each rectangle in the drawn-to region, the rectangle is compressed using an RGB codec and, at 926, sent via a protocol command. When the last rectangle is sent, processing is complete.

If the command is not a PutImage to a realized window, then at 928 it is determined if the command is an opaque PolyFillRect to a pixmap. It should be noted that one of ordinary skill in the art will recognize that an opaque poly fill rectangle command, any command utilized to overwrite a rectangle with a single color or a tiled pattern, could be substituted for PolyFillRect. PolyFillRect commands are frequently used to set a region to the background color or pattern. In the case of the X Windows System, a PolyFillRect command is opaque when the graphics context indicates that (a) all color planes are affected; (b) the logical function is GXcopy, GXclear, GXset, or GXcopyInverted; and (c) the fill style is solid, tiled, or opaque strippled (i.e., the style is not stippled). If the command is an opaque PolyFillRect command, then at 930 the drawn-to region is computed. Then at 932, the drawn-to region is removed from the pixmap's RGB region. This special handling of PolyFillRect commands is useful to prevent the waste of CPU resources that would result from applying an RGB codec to a region where an RGB image has been overwritten by a non-RGB image. Note that if the PolyFillRect command is not opaque, then any pre-existing RGB image is not fully overwritten and so the RGB region is not adjusted.

Referring now to FIG. 9B, if the command is not an opaque PolyFillRect to a pixmap, then at 934 it is determined if the command is an opaque ImageText to a pixmap. If so, at 936, the drawn-to region is computed. Then, at 938, the drawn-to region is subtracted from the pixmap's RGB region and processing is complete.

If the command is not an opaque ImageText to a pixmap, then at 940 it is determined if the command is a CopyArea from a pixmap to a pixmap. If so, then at 942, the drawn-to region is computed. Then at 944, it is determined if the CopyArea is opaque. If so, then at 946, the drawn-to region is removed from the RGB region of the destination pixmap. Then at 948, the RGB portion of the drawn-to region is found by translating the RGB region of the source pixmap to the destination coordinates and intersecting with the drawn-to region. The destination coordinates are those coordinates in the destination pixmap to which the CopyArea command copies the source pixmap. Then at 950, the RGB portion of the drawn-to region is added to the RGB region of the destination pixmap. This sequence ensures proper handling when an RGB image in the destination pixmap is overwritten, and when an RGB image in the source pixmap is used to create an RGB image in the destination pixmap.

If the command is not a CopyArea from a pixmap to a pixmap, then at 952 it is determined if the command is a CopyArea from a pixmap to a realized window. If not, then the system may simply perform standard SunRay™ post-processing of the command at 954. For example, if the command renders to a realized window, then the SunRay™ software sends the appropriate screen update information to the display computer.

If the command is a CopyArea from a pixmap to a realized window, then at 956 the drawn-to region is computed. Then at 958, the RGB portion of the drawn-to region may be found by translating the RGB region of the source pixmap to the destination coordinates and intersecting with the drawn-to region. The destination coordinates are those screen coordinates to which the CopyArea command copies the pixmap. At 960, the non-RGB portion of the drawn-to-region is sent to the display computer using the standard SunRay™ method. Then at 962, it is determined if there are more RGB rectangles. Then, for each rectangle in the RGB portion, the rectangle is compressed using an RGB codec at 964 and sent via a protocol command at 966. When the last rectangle is sent, processing is complete.

The rationale for the special handling of drawing primitives such as PolyFillRectangle and ImageText but not for others such as PolyArc and PolyText is that the former routines are typically used to overwrite rectangular areas of the destination drawable's image. Thus taking them into account reduces the size of the RGB region without significantly increasing the number of rectangles in the RGB region. The regions overwritten by the other commands tend to be irregularly-shaped (non-rectangular), so taking them into account would carve the RGB region up into a large number of smaller rectangles which do not compress as well with an RGB codec. Note that if the RGB codec is too lossy, this method can result in visible degradation of such non-RGB images included in the RGB region. Fortunately, it is relatively rare for such non-RGB images to be drawn on top of RGB images. Still, the problem can be avoided by use of lossless or nearly-lossless codecs. In principle, the practitioner can even keep track of two separate RGB regions: a “pure” RGB region which has not been overwritten by PolyArc, etc. and an “impure” RGB region which has. The pure RGB region could then be compressed with a lossy codec and the impure RGB region could be compressed with a lossless or nearly-lossless codec.

Since best compression results when the RGB region is composed of large rectangles, the method described in FIGS. 9A-9B may be refined. In this refinement, addition to and subtraction from the pixmap's RGB region would only occur if the drawn-to region is deemed to be sufficiently large.

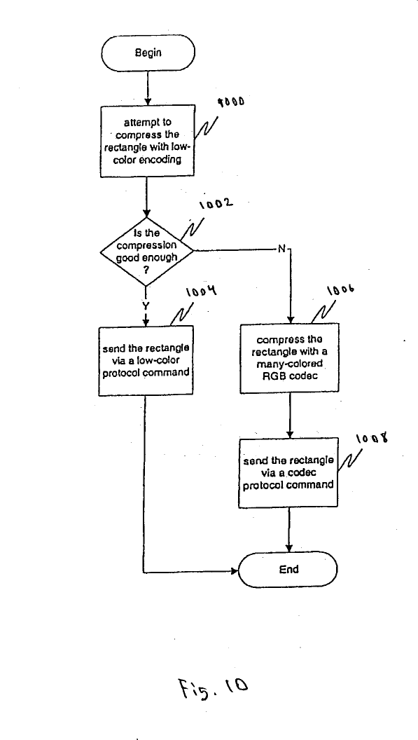

In a specific embodiment of the present invention, 924 of FIG. 9A and 964 of FIG. 9B may be more complicated than merely using a single codec. RGB images tend to fall into one of two broad categories: (1) many-colored pictures which typically compress well with RGB codecs, and (2) low-colored images for which higher compression may result through the use of low-color and/or run-length encoding. FIG. 10 is a flow diagram illustrating a method for compressing a rectangle in accordance with a specific embodiment of the present invention. This method could conceivably replace 924-926 of FIG. 9A and 964-966 of FIG. 9B. At 1000, an attempt is made to compress the rectangle with low-color encoding. At 1002, it is determined if the compression is good enough. If so, then at 1004 the rectangle may be sent via a low-color protocol command. If not, then at 1006 the rectangle may be compressed with a many-colored RGB codec. Examples include Differential Pulse Code Modulation (DPCM) and Discrete Cosine Transform (DCT). The choice as to which codec to apply may be based on the available bandwidth: DCT requires more thin client CPU cycles but achieves better compression. Then at 1008, the rectangle may be sent via a codec protocol command. One of ordinary skill in the art will recognize that such a technique can easily be generalized to select an appropriate match from any number of image compression schemes.

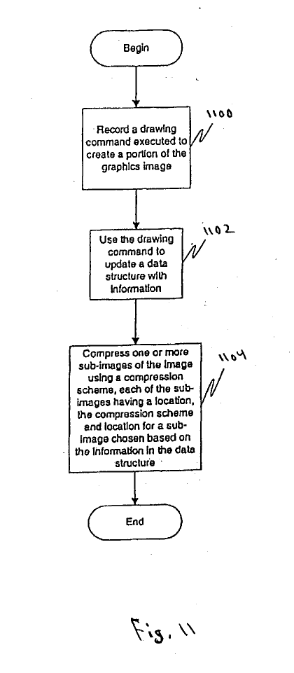

FIG. 11 is a flow diagram illustrating a method for reducing the size of a composite graphics image in a computer system in accordance with a specific embodiment of the present invention. In this embodiment, a certain class of image data (e.g., RGB sub-images) are singled out for special compression, using a compression mode appropriate for the class of image data. A set of one or more drawing commands (e.g. PutImage and CopyArea from a pixmap containing one or more RGB sub-images) may be identified as creating sub-images of this class. Another set of one or more drawing commands (e.g., opaque PolyFillRect) may be identified as overwriting sub-images of this class.

At 1100, a drawing command is recorded. Command recording may or may not be limited to commands from the two sets of drawing commands identified above. This drawing command may also be one that is executed during the rendering of said composite graphics image. The graphics image may be created in a pixmap. At 1102, the drawing command is used to update a data structure with information. This may include using information about the region drawn to by the drawing command to update the data structure. This data structure may be associated with the pixmap. A private data field, such as a devPrivates field, may be used to attach the data structure to the pixmap. While use of the X Windows devPrivates facility would be one method of associating a data structure with the pixmap, there are other possible choices for the method of associating the two.

The information in the data structure may enable determination of what portion of the composite image contains sub-images of the specified image class. One example data structure would be a bitmask identifying which pixels were rendered with a specific drawing command. Alternatively, the data structure may be a series of partially-transparent overlap layers which would reconstruct the full pixmap image when combined, where a different layer is kept for each command. In a specific embodiment of the present invention, an X region resource is used to store the region of the pixmap which contains sub-images of the specified image class.

At 1104, one or more sub-images from the composite graphics image may be compressed using a compression scheme, with both the location of the sub-images and the compression scheme based on the information in the data structure. It should be noted that the compressor does not necessarily need to know exactly which drawing commands were executed. It only needs to know what sub-images of the image should be compressed with a given compression scheme. 1104 may occur when the XCopyArea command is used to copy a portion of the off-screen pixmap to a realized window. The compressor may use the information in the data structure to find the location within the composite image of sub-images of the specified image class. The compressor may compress these sub-images using a compression scheme selected for the specified image class. If the region covered by the sub-images is represented as a set of one or more rectangles, as is the case for the X region resource, each rectangle may be compressed and sent independently.

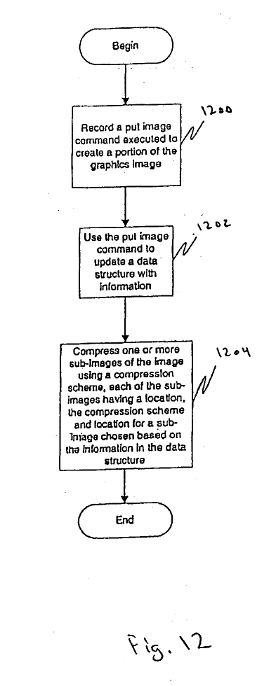

FIG. 12 is a flow diagram illustrating a method for reducing the size of a graphics image in a computer system in accordance with a specific embodiment of the present invention. At 1200, a put image command executed to create a portion of the graphics image in a pixmap may be recorded. At 1202, the put image command is used to update a data structure with information. This may include using information about the region to which the put image command applies to update the data structure. The data structure may be an X region resource identifying the region that was rendered by one or more put image commands. The data structure may also be a series of partially-transparent overlap layers. It may also be a bitmask identifying which pixels were rendered with the put image command. At 1204, one or more sub-images from the composite graphics image may be compressed using a compression scheme, with both the location of the sub-images and the compression scheme based on the information in the data structure.

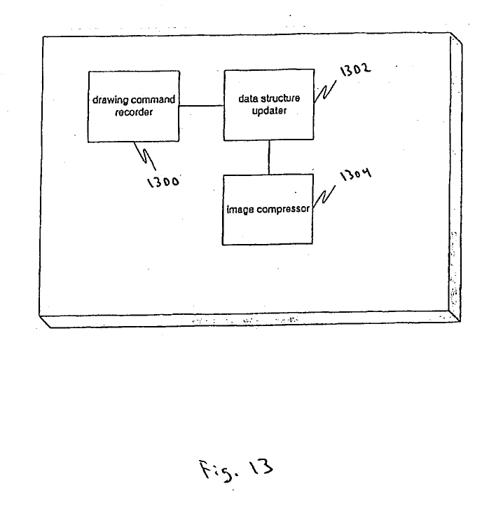

FIG. 13 is a block diagram illustrating an apparatus for reducing the size of a composite graphics image in a computer system in accordance with a specific embodiment of the present invention. In this embodiment, a certain class of image data (e.g., RGB sub-images) are singled out for special compression, using a compression mode appropriate for the class of image data. A set of one or more drawing commands (e.g. CopyArea from a pixmap containing one or more RGB sub-images and PutImage) may be identified as creating sub-images of this class. Another set of one or more drawing commands (e.g., opaque PolyFillRect) may be identified as overwriting sub-images of this class.

A drawing command recorder 1300 may record a drawing command. Command recording may or may not be limited to commands from the two sets of drawing commands identified above. This drawing command may also be one that is executed during the rendering of said composite graphics image. The graphics image may be created in a pixmap. A data structure update 1302 coupled to the drawing command recorder 1300 may use the drawing command to update a data structure with information. This may include using information about the region drawn to by the drawing command to update the data structure. This data structure may be associated with the pixmap. A private data field, such as a devPrivates field, may be used to attach the data structure to the pixmap. While use of the X Windows devPrivates facility would be one method of associating a data structure with the pixmap, there are other possible methods for associating the two.

The information in the data structure may enable determination of what portion of the composite image contains sub-images of the specified image class. One example data structure would be a bitmask identifying which pixels were rendered with a specific drawing command. Alternatively, the data structure may be a series of partially-transparent overlap layers, where a different layer is kept for each command. In a specific embodiment of the present invention, an X region resource is used to store the region of the pixmap which contains sub-images of the specified image class.

An image compressor 1304 coupled to said data structure update 1302 may compress one or more sub-images from the composite graphics image using a compression scheme, with both the location of the sub-images and the compression scheme based on the information in the data structure. It should be noted that the compressor does not necessarily need to know exactly which drawing commands were executed. It only needs to know what sub-images of the image should be compressed with a given compression scheme. The compression may occur when the XcopyArea command is used to copy a portion of the off-screen pixmap to a realized window. The compressor may use the information in the data structure to find the location within the composite image of sub-images of the specified image class. The compressor may compress these sub-images using a compression scheme selected for the specified image class. If the region covered by the sub-images is represented as a set of one or more rectangles, as is the case for the X region resource, each rectangle may be compressed and sent independently.

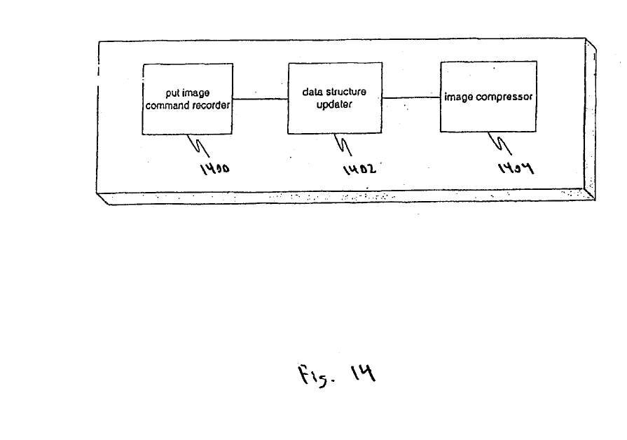

FIG. 14 is a block diagram illustrating an apparatus for reducing the size of a graphics image in a computer system in accordance with a specific embodiment of the present invention. A put image command recorder 1400 may record a put image command executed to create a portions of the graphics image in a pixmap. A data structure update 1402 coupled to said put image command recorder 1400 may use the put image command to update a data structure with information. This may include using information about the region to which the put image command applies to update the data structure. The data structure may be an X region resource identifying the region that was rendered by the put image command. The data structure may also be a series of partially-transparent overlap layers. It may also be a bitmask identifying which pixels were rendered with the put image command. An image compressor 1404 coupled to said data structure update 1402 may compress one or more sub-images from the composite graphics image using a compression scheme, with both the location of the sub-images and the compression scheme based on the information in the data structure.

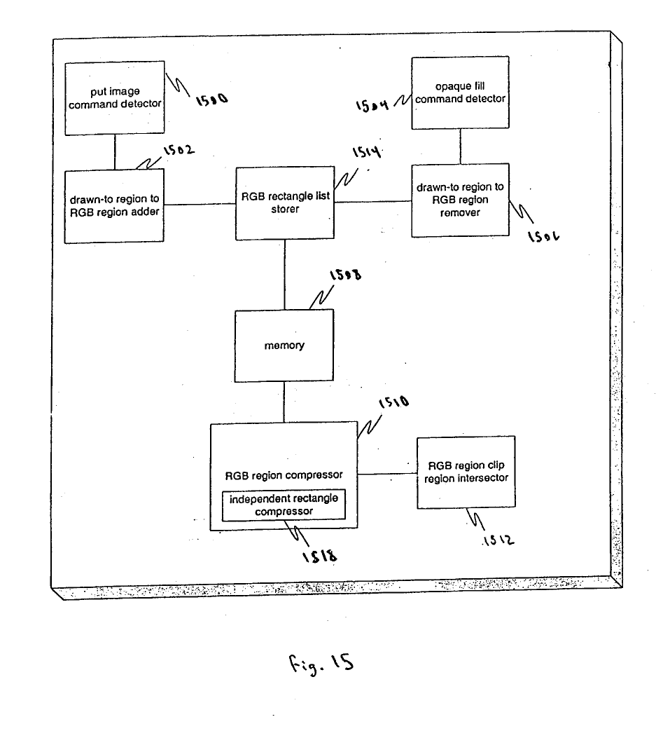

FIG. 15 is a block diagram illustrating an apparatus for reducing the size of a graphics image in a computer system in accordance with a specific embodiment of the present invention. A put image command detector 1500 detects when a put image command executed. A drawn-to region to RGB region adder 1502 coupled to the put image command detector 1500 adds a drawn-to region to an RGB region when a put image command is executed. An opaque fill command detector 1504 detects when an opaque fill command is executed. A drawn-to region to RGB region remover 1506 coupled to the opaque fill command detector 1504 removes a drawn-to region from the RGB region when an opaque fill command is executed. A memory 1508 coupled to the drawn-to region to RGB region remover 1506 may store the RGB region. An RGB region compressor 1510 coupled to the memory 1508 may then compress the RGB region before transmitting it for display. An RGB region clip region intersector 1512 coupled to the memory 1508 and to the RGB region compressor 1510 may intersect the RGB region with a clip region before compression occurs. For example, the clip region may be the composite clip region, the window clip list (where overlapping windows have been subtracted away), or the client clip list. An RGB region rectangle list store 1516 coupled to the drawn-to region to RGB region adder 1502, the drawn-to region to RGB region remover 1506, and the memory 1508 may store the RGB region as a series of rectangles. Then an independent rectangle compressor 1518 within the RGB region compressor 1510 may compress each rectangle independently.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A method for buffering image updates for a remote application, comprising:
accessing an image update produced by a remote application for transmission from a host computer system to a display computer system;
buffering the image update to generate an image data set, wherein the image data set is configured for processing by an image compression routine, the buffering performed by the host computer system;
processing the image data set using the image compression routine to produce a compressed image data set; and
transmitting the compressed image data set to the display computer system via a network connection.

2. The method of claim 1 wherein the image data set comprises a plurality of lines of the image update, wherein the lines are configured for processing by the image compression routine.

3. The method of claim 1 wherein the image data set comprises a plurality of image blocks, wherein the blocks are configured for processing by the image compression routine.

4. The method of claim 3 wherein a symmetric pixel grouping comprises each of the plurality of blocks, and wherein a number of pixels within the grouping is configured for processing by the image compression routine.

5. The method of claim 1 wherein the image compression routine is an RGB image codec.

6. The method of claim 1 further comprising:
transmitting the compressed image data set to the display computer system asynchronously via the network connection.

7. The method of claim 1 wherein the host computer system runs an X-server application for processing the image update.

8. A method for buffering image updates for a remote application, comprising:
accessing an image update produced by a remote application for transmission from a host computer system to a display computer system;
buffering the image update to generate a plurality of blocks of the image update, wherein the blocks are configured for processing by an image codec, the buffering performed by the host computer system;
processing the blocks using the image codec to produce compressed image blocks; and
transmitting the compressed image blocks to the display computer system via a network connection.

9. The method of claim 8 wherein a symmetric pixel grouping comprises each of the plurality of blocks, and wherein a number of pixels within the grouping is configured for processing by the image codec.

10. The method of claim 8 wherein the image codec is an RGB image codec.

11. The method of claim 8 further comprising:
transmitting the compressed image blocks to the display computer system asynchronously via the network connection.

12. The method of claim 8 wherein the host computer system runs an X-server application for processing the image update.

13. A host computer system for buffering image updates for a remote application, comprising:
a computer system having a processor coupled to a memory, the memory having computer readable code which when executed by the processor causes the computer system to implement a method comprising:
accessing an image update produced by a remote application for transmission from the host computer system to a display computer system;
buffering the image update to generate a plurality of blocks of the image update, wherein the blocks are configured for processing by an image codec;
processing the blocks using the image codec to produce compressed image blocks; and
transmitting the compressed image blocks to the display computer system via a network connection.

14. The system of claim 13 wherein a symmetric pixel grouping comprises each of the plurality of blocks, and wherein a number of pixels within the grouping is configured for processing by the image codec.

15. The system of claim 13 wherein the image codec is an RGB image codec.

16. The system of claim 13 further comprising:
transmitting the compressed image blocks to the computer system asynchronously via the network connection.

17. The system of claim 13 further comprising:
accessing a tagged multicolor image that comprises the image update, wherein the tagged multicolor image identifies the plurality of blocks.

18. The system of claim 13 wherein the host computer system runs an X-server application for processing the image update.

19. A computer readable media having computer readable code which when executed by a computer system cause the computer system to implement a method for buffering image updates for a remote application comprising:
accessing an image update produced by a remote application for transmission from a host computer system to a display computer system;
buffering the image update to generate a plurality of blocks of the image update, wherein the blocks are configured for processing by an image codec, the buffering performed by the host computer system;
processing the blocks using the image codec to produce compressed image blocks; and
transmitting the compressed image blocks to the display computer system via a network connection.

20. The computer readable media of claim 19 wherein a symmetric pixel grouping comprises each of the plurality of blocks, and wherein a number of pixels within the grouping is configured for processing by the image codec.

21. The computer readable media of claim 19 wherein the image codec is an RGB image codec.

22. The computer readable media of claim 19 further comprising:
transmitting the compressed image blocks to the computer system asynchronously via the network connection.

23. The computer readable media of claim 19 wherein the host computer system runs an X-server application for processing the image update.

24. A method for reducing the size of a graphics image in a computer system by using buffering, comprising:
recording a drawing command executed to create a portion of the graphics image; and compressing said portion of the graphics image using a compression scheme, said compression scheme selected based on said drawing command, said compression scheme comprising:
buffering the portion to generate an image data set, wherein the image data set is configured for processing by an image compression routine, the buffering performed by a host computer system;
processing the image data set using the image compression routine to produce a compressed image data set; and
transmitting the compressed image data set to a display computer system via a network connection.

25. The method of claim 24 further comprising:
using said drawing command to update a data structure associated with said portion with information; and
compressing one or more sub-images of the graphics image using said compression scheme, each of said sub-images having a location, said location and said compression scheme for each of said sub-images chosen based on said information in said data structure.

26. The method of claim 25, wherein said data structure is associated with said portion using a private data field attached to said portion.

27. The method of claim 26, wherein said private data field is a pixmap devPrivates field.

28. The method of claim 26, wherein said data structure associated with said portion identifies the portion of a pixmap image that was created with a specific drawing command.

29. The method of claim 26, wherein said data structure associated with said portion is a list of rectangles specifying which pixels were rendered with a specific drawing command.

30. A method for buffering image updates for a remote application, comprising:
recording a put image command executed to create a portion of the graphics image in a pixmap;
using said put image command to update a data structure associated with said pixmap with information; and
compressing one or more sub-images of the graphics image using a compression scheme, each of said sub-images having a location, said location and said compression scheme for each of said sub-images chosen based on said information in said data structure, and wherein at least one compression scheme comprises:
buffering the pixmap to generate an image data set, wherein the image data set is configured for processing by an image compression routine, the buffering performed by a host computer system;
processing the image data set using the image compression routine to produce a compressed image data set; and
transmitting the compressed image data set to a display computer system via a network connection.

31. The method of claim 30, wherein said data structure associated with said pixmap identifies the portion of the pixmap image that was created with a specific drawing command.

32. The method of claim 31, wherein said data structure associated with said pixmap is a list of rectangles specifying which pixels were rendered with a specific drawing command.

33. The method of claim 30, wherein said compression scheme is an RGB codec.
